(19) United States
(12) Patent Application Publication
(10) Pub. No.: US 2025/0208984 A1
(43) Pub. Date: Jun. 26, 2025

(54) AUTOMATED SCHEDULING OF SOFTWARE APPLICATION TEST CASE EXECUTION ON INFORMATION TECHNOLOGY ASSETS

(71) Applicant: Dell Products L.P., Round Rock, TX (US)

(72) Inventors: Michael Chen, Chengdu (CN); Jessica Jing Ye, Chengdu (CN); Kiko Nan Wang, Chengdu (CN); Yang Wu, Chengdu (CN); Ming Yue, Chengdu (CN); Ilan Yosef, Petach Tiqva (IL); Zhao Li, Chengdu (CN)

(21) Appl. No.: 18/392,541

(22) Filed: Dec. 21, 2023

(51) Int. Cl. G06F 11/36

(52) U.S. Cl. CPC G06F 11/3688; G06F 11/3684

(57) ABSTRACT

Techniques are provided for automated scheduling of software application test case execution on information technology (IT) assets. One method comprises obtaining information characterizing (i) test cases that evaluate software issues related to a software application, (ii) IT assets that execute the test cases and (iii) execution times of the test cases on the IT assets, wherein at least one execution time of a given test case on a particular IT asset comprises a predicted execution time, wherein the at least one predicted execution time is predicted using an actual execution time of the given test case on one or more different IT assets than the particular IT asset; automatically generating, using the execution times of the test cases on the IT assets, a schedule for additional executions of at least some of the test cases on the IT assets; and initiating one or more automated actions based on the schedule.

### BACKGROUND

Information processing systems include a wide variety of information technology (IT) assets that execute software applications, for example. It is often necessary to execute test cases to evaluate reported issues related to an operation of a given software product. Conventional approaches for scheduling the execution of such test cases, however, can have a number of deficiencies that can result in a test case execution that does not provide an efficient utilization of resources.

### SUMMARY

Illustrative embodiments of the disclosure provide techniques for automated scheduling of software application test case execution on IT assets. An exemplary method comprises obtaining information characterizing a plurality of test cases that evaluate one or more software issues related to a software application; obtaining information characterizing a plurality of IT assets, of an IT infrastructure, that execute one or more of the plurality of test cases; obtaining information characterizing an execution time of one or more of the plurality of test cases on one or more of the plurality of IT assets, wherein at least one execution time of a given one of the plurality of test cases on a particular one of the plurality of IT assets comprises at least one predicted execution time, wherein the at least one predicted execution time is predicted using at least one actual execution time of the given test case on one or more different IT assets than the particular IT asset; automatically generating, using the information characterizing the execution time of the one or more test cases on the one or more IT assets, a schedule for additional executions of at least a subset of the plurality of test cases on respective ones of the plurality of IT assets; and initiating one or more automated actions based at least in part on the schedule.

Illustrative embodiments can provide significant advantages relative to conventional techniques for scheduling the execution of software application test cases. For example, problems associated with time-consuming and error-prone manual scheduling techniques are overcome in one or more embodiments by monitoring execution times of test cases on IT assets and automatically generating a test case execution schedule using the monitored execution times.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for automated scheduling of software application test case execution on IT assets in an illustrative embodiment;

FIG. 2 is a flow diagram illustrating an exemplary implementation of a prediction function generation process, according to one embodiment of the disclosure;

FIG. 3 is an example table illustrating an execution history for a particular test case according to an embodiment;

FIG. 4 is an example table illustrating a preprocessed execution history, for the particular test case of FIG. 3, that is used as training data for the linear regression analysis of FIG. 2 according to embodiments of the disclosure;

FIG. 5 comprises a regression statistics summary table and a prediction function coefficients table, according to embodiments of the disclosure;

FIG. 6 is an example table illustrating a test case execution time matrix, according to an embodiment of the disclosure;

FIG. 7 illustrates a scheduling optimizer, according to one embodiment of the disclosure;

FIG. 8 comprises an exemplary test case execution schedule and a device/test case assignment table, according to embodiments of the disclosure;

FIG. 9 is a flow diagram illustrating an exemplary implementation of a process for automated scheduling of software application test case execution on IT assets, according to an embodiment; and

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

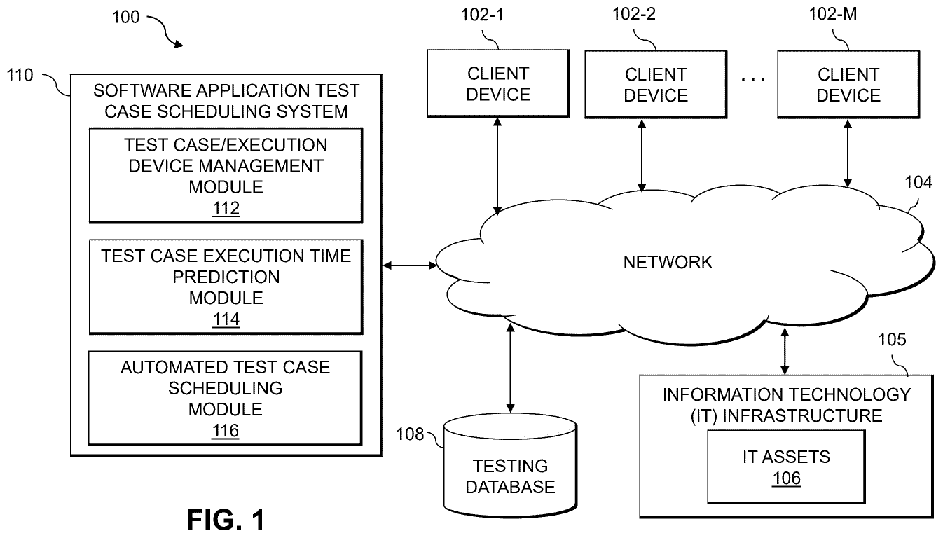

FIG. 1 shows an information processing system 100 configured in accordance with an illustrative embodiment. The information processing system 100 is assumed to be built on at least one processing platform and provides functionality for automated scheduling of software application test case execution on IT assets. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a testing database 108, and a software application test case scheduling system 110. The IT assets 106 may comprise physical and/or virtual computing resources in the IT infrastructure 105. Physical computing resources may include physical hardware such as servers, host devices, storage systems, networking equipment, Internet of Things (IoT) devices, other types of processing and computing devices including desktops, laptops, tablets, smartphones, etc. Virtual computing resources may include virtual machines (VMs), containers, etc.

The IT assets 106 of the IT infrastructure 105 may host software applications that are utilized by respective ones of the client devices 102, such as in accordance with a client-server computer program architecture. In some embodiments, the software applications comprise web applications designed for delivery from assets in the IT infrastructure 105 to users (e.g., of client devices 102) over the network 104. Various other examples are possible, such as where one or more software applications are used internal to the IT infrastructure 105 and not exposed to the client devices 102. It should be appreciated that, in some embodiments, some of the IT assets 106 of the IT infrastructure 105 may themselves be viewed as applications or more generally software or hardware that is to be evaluated. For example, individual ones of the IT assets 106 that are virtual computing resources implemented as software containers may represent software that is to be evaluated.

The software application test case scheduling system 110 utilizes various information stored in the testing database 108, such as execution logs providing information obtained from executions of one or more test cases on various IT assets 106, to automatically schedule such software application test cases. In some embodiments, the software application test case scheduling system 110 is used for an enterprise system. For example, an enterprise may subscribe to or otherwise utilize the software application test case scheduling system 110 to automatically schedule software application test cases. As used herein, the term “enterprise system” is intended to be construed broadly to encompass any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The testing database 108, as discussed above, is configured to store and record various information, such as execution logs providing information obtained from executions of one or more test cases on various IT assets 106, which is used by the software application test case scheduling system 110 to automatically schedule software application test cases. Such information may include, but is not limited to, information regarding execution of one or more software applications, test cases, testing objectives, testing points, test coverage, testing plans, etc. The testing database 108 in some embodiments is implemented using one or more storage systems or devices associated with the software application test case scheduling system 110. In some embodiments, one or more of the storage systems utilized to implement the testing database 108 comprise a scale-out all-flash content addressable storage array or other type of storage array.

The term “storage system” as used herein is therefore intended to be broadly construed and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the software application test case scheduling system 110, as well as to support communication between the software application test case scheduling system 110 and other related systems and devices not explicitly shown.

The client devices 102 are configured to access or otherwise utilize the IT infrastructure 105. In some embodiments, the client devices 102 are assumed to be associated with users that execute one or more software applications and report bugs or other issues encountered with such executions. In other embodiments, the client devices 102 are assumed to be associated with system administrators, IT managers or other authorized personnel responsible for managing the IT assets 106 of the IT infrastructure 105 (e.g., where such management includes performing testing of the IT assets 106, or of applications or other software that runs on the IT assets 106). For example, a given one of the client devices 102 may be operated by a user to access a graphical user interface (GUI) provided by the software application test case scheduling system 110 to manage testing plans (e.g., create, review, execute, etc.). The software application test case scheduling system 110 may be provided as a cloud service that is accessible by the given client device 102 to allow the user thereof to manage testing plans. In some embodiments, the IT assets 106 of the IT infrastructure 105 are owned or operated by the same enterprise that operates the software application test case scheduling system 110 (e.g., where an enterprise such as a business provides support for the assets it operates). In other embodiments, the IT assets 106 of the IT infrastructure 105 may be owned or operated by one or more enterprises different than the enterprise which operates the software application test case scheduling system 110 (e.g., a first enterprise provides support for assets that are owned by multiple different customers, business, etc.). Various other examples are possible.

In other embodiments, the software application test case scheduling system 110 may provide support for testing of the client devices 102, instead of or in addition to providing support for the IT assets 106 of the IT infrastructure 105. For example, the software application test case scheduling system 110 may be operated by a hardware vendor that manufactures and sells computing devices (e.g., desktops, laptops, tablets, smartphones, etc.), and the client devices 102 represent computing devices sold by that hardware vendor. The software application test case scheduling system 110 may also or alternatively be operated by a software vendor that produces and sells software (e.g., applications) that runs on the client devices 102. The software application test case scheduling system 110, however, is not required to be operated by any single hardware or software vendor. Instead, the software application test case scheduling system 110 may be offered as a service to provide support for computing devices or software that are sold by any number of hardware or software vendors. The client devices 102 may subscribe to the software application test case scheduling system 110, so as to provide support for testing and/or evaluation of the client devices 102 or software running thereon. Various other examples are possible.

In some embodiments, the client devices 102 may implement host agents that are configured for automated transmission of information regarding a state of the client devices 102 (e.g., such as in the form of testing and/or execution logs periodically provided to the testing database 108 and/or the software application test case scheduling system 110). Such host agents may also or alternatively be configured to automatically receive from the software application test case scheduling system 110 commands to execute remote actions (e.g., to run various test steps and/or test cases on the client devices 102 and/or the IT assets 106 of the IT infrastructure 105). Host agents may similarly be deployed on the IT assets 106 of the IT infrastructure 105.

It should be noted that a “host agent” as this term is generally used herein may comprise an automated entity, such as a software entity running on a processing device. Accordingly, a host agent need not be a human entity.

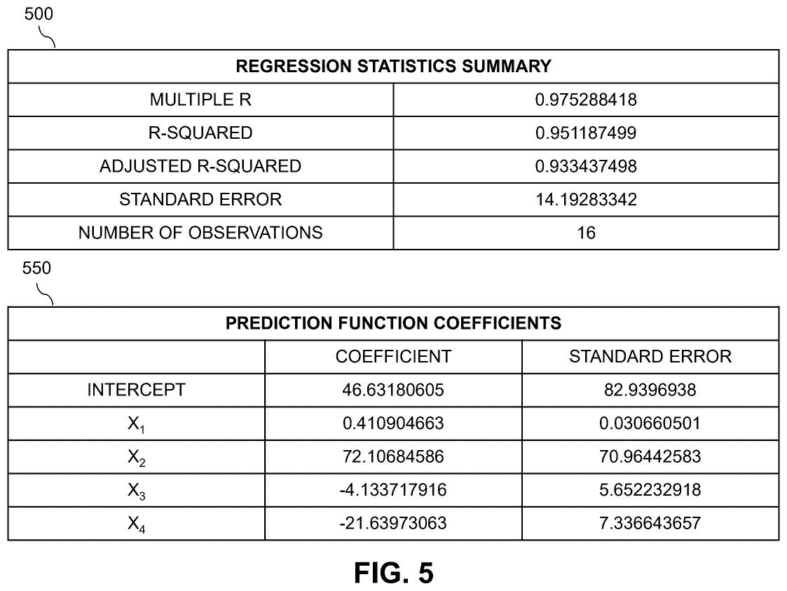

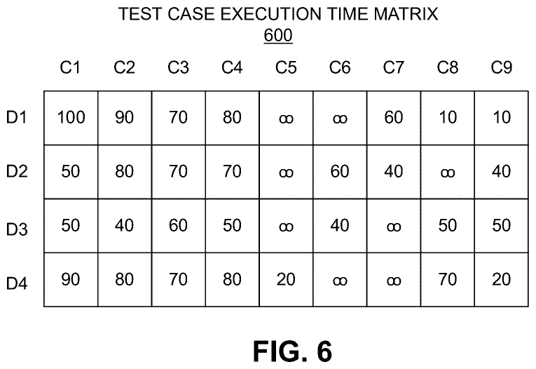

The software application test case scheduling system 110 in the FIG. 1 embodiment is assumed to be implemented using at least one processing device. Each such processing device generally comprises at least one processor and an associated memory, and implements one or more functional modules or logic for controlling certain features of the software application test case scheduling system 110. In the FIG. 1 embodiment, the software application test case scheduling system 110 comprises a test case/execution device management module 112, a test case execution time prediction module 114 and an automated test case scheduling module 116. The test case/execution device management module 112 is configured to manage the execution of various test cases on various IT assets 106, maintain configuration information for such IT assets 106 and provide execution logs from such executions to the testing database 108. The test case execution time prediction module 114 is configured to generate one or more prediction functions that predict test case execution times using machine learning algorithms, as discussed further below in conjunction with FIG. 5, for example. The automated test case scheduling module 116 is configured to process a test case execution time matrix, generated at least in part by the test case execution time prediction module 114, to generate a test case execution schedule, as discussed further below in conjunction with FIGS. 6 through 8. The software application test case scheduling system 110 is further configured, either directly or via one or more of the client devices 102, to execute the scheduled test cases on one or more of the IT assets 106 of the IT infrastructure 105.

It is to be appreciated that the particular arrangement of the client devices 102, the IT infrastructure 105 and the software application test case scheduling system 110 illustrated in the FIG. 1 embodiment is presented by way of example only, and alternative arrangements can be used in other embodiments. As discussed above, for example, the software application test case scheduling system 110 (or portions of components thereof, such as one or more of the test case/execution device management module 112, the test case execution time prediction module 114 and the automated test case scheduling module 116) may in some embodiments be implemented internal to one or more of the client devices 102 and/or the IT infrastructure 105.

At least portions of the test case/execution device management module 112, the test case execution time prediction module 114 and the automated test case scheduling module 116 may be implemented at least in part in the form of software that is stored in memory and executed by a processor.

The software application test case scheduling system 110 and other portions of the information processing system 100, as will be described in further detail below, may be part of cloud infrastructure.

The software application test case scheduling system 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the testing database 108 and the software application test case scheduling system 110 or components thereof (e.g., the test case/execution device management module 112, the test case execution time prediction module 114 and the automated test case scheduling module 116) may be implemented on respective distinct processing platforms, although numerous other arrangements are possible. For example, in some embodiments at least portions of the software application test case scheduling system 110 and one or more of the client devices 102, the IT infrastructure 105 and/or the testing database 108 are implemented on the same processing platform. A given client device (e.g., client device 102-1) can therefore be implemented at least in part within at least one processing platform that implements at least a portion of the software application test case scheduling system 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the testing database 108 and the software application test case scheduling system 110, or portions or components thereof, to reside in different data centers. Numerous other distributed implementations are possible. The software application test case scheduling system 110 can also be implemented in a distributed manner across multiple data centers.

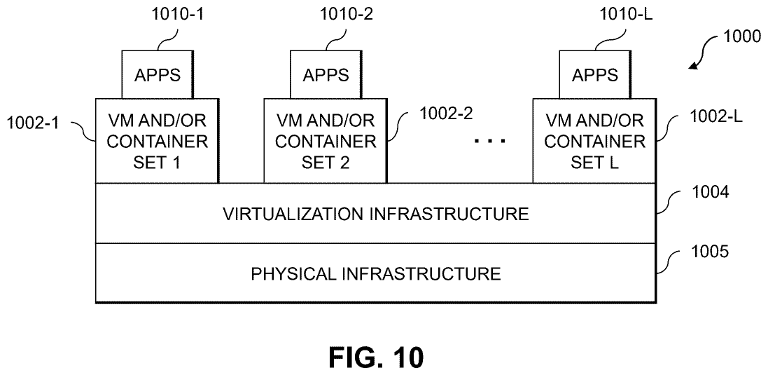

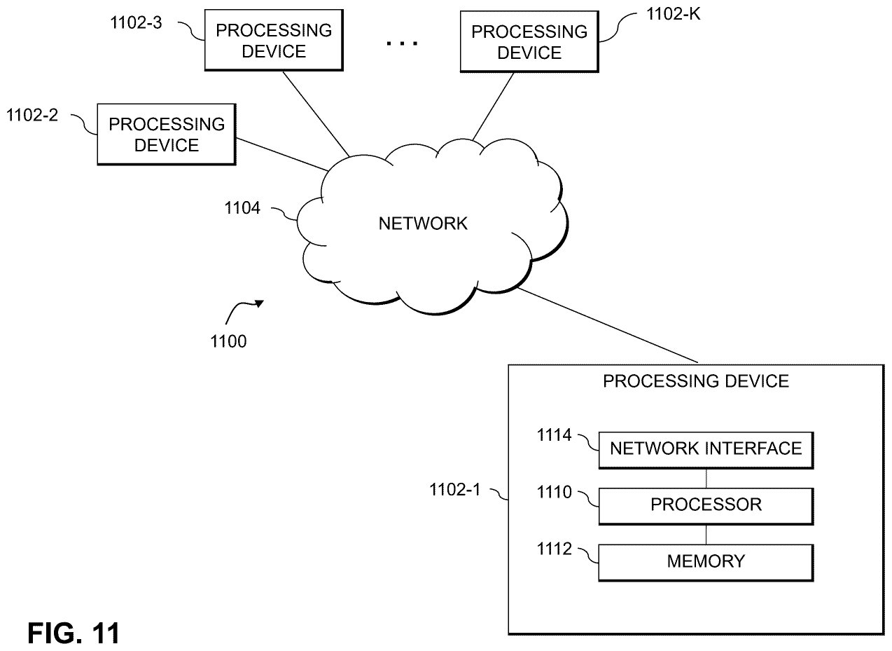

Additional examples of processing platforms utilized to implement the software application test case scheduling system 110 and other components of the information processing system 100 in illustrative embodiments will be described in more detail below in conjunction with FIGS. 10 and 11.

It is to be appreciated that these and other features of illustrative embodiments are presented by way of example only and should not be construed as limiting in any way.

It is to be understood that the particular set of elements shown in FIG. 1 for automated scheduling of software application test case execution on IT assets is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only and should not be construed as limiting in any way.

Illustrative embodiments provide techniques for automatically scheduling software application test case execution. In some embodiments, the disclosed software application test case scheduling techniques are based at least in part on an analysis of system testing logs or other records of test case execution histories to improve automated scheduling of software application test cases on IT assets.

In one or more embodiments, text case execution logs are processed that provide test case execution times, obtained from executions of various test cases on various IT assets 106, in order to automatically schedule the execution of such software application test cases. Execution histories for some test cases, however, may not be available for all IT assets 106. Thus, the test case execution time prediction module 114 is employed in some embodiments to predict execution times for one or more test cases on one or more IT assets 106 when an actual execution history is not available.

Consider an example system having N test cases and M free test devices. A test case set vector, C, comprises N test cases, as follows:
C={c₁, c₂ . . . cₙ}.

In addition, a test device set vector, D, comprises M test devices, as follows:
D={d₁, d₂ . . . dₘ}.

A test case execution time vector comprises an execution time for each test device, dᵢ, with an entry for each test case in the test case set vector, C, as follows:
t(dᵢ)={tᵢ₁, tᵢ₂ . . . tᵢₙ}.

In one or more embodiments, the test case execution time vector determines the accuracy of the scheduling algorithm. One or more of the test case execution times tᵢⱼ (e.g., a test device dᵢ executing test case cⱼ) can be obtained from the execution history in the testing database 108. The test case execution times tᵢⱼ (e.g., for a given test device dᵢ executing a given test case cⱼ) may be stored in a test case execution time matrix, as discussed further below in conjunction with FIG. 6. If a given test case execution time, tᵢⱼ, does not exist, however, a prediction formula is used to predict the given test case execution time, tᵢⱼ.

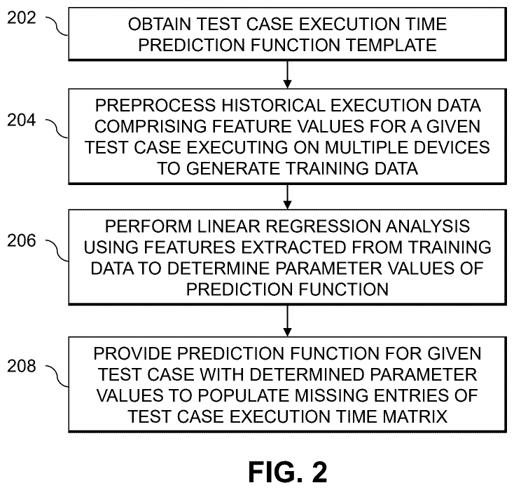

FIG. 2 is a flow diagram illustrating an exemplary implementation of a prediction function generation process, according to one embodiment of the disclosure. In the example of FIG. 2, each iteration of the process generates a prediction function for a given test case. In step 202, a test case execution time prediction function template is obtained. For example, the test case execution time prediction function (h_{θ}(x)) template may be expressed as follows:

$${h}_{θ} ( x ) = {θ}_{0} + {θ}_{1} {x}_{1} + {θ}_{2} {x}_{2} + … + {θ}_{k} {x}_{k} ,$$

where x₁, x₂, x₃, . . . , xₖ are input features that will be extracted from the training data for the given test case. In some embodiments, eigenvalues are used to represent a magnitude or importance of various test case execution features (e.g., larger eigenvalues may correlate with more important features) during a feature selection phase. For example, four features x₁ . . . , x₄ may be employed for a given test case execution history in some embodiments. In addition, θ₀, θ₁, θ₂, . . . θₖ are parameter values (e.g., weights) of the test case execution time prediction function that will be determined by the prediction function generation process of FIG. 2. Generally, the execution time of the given test case is related to one or more attributes, such as parameters of the given test case and a configuration of a particular test device.

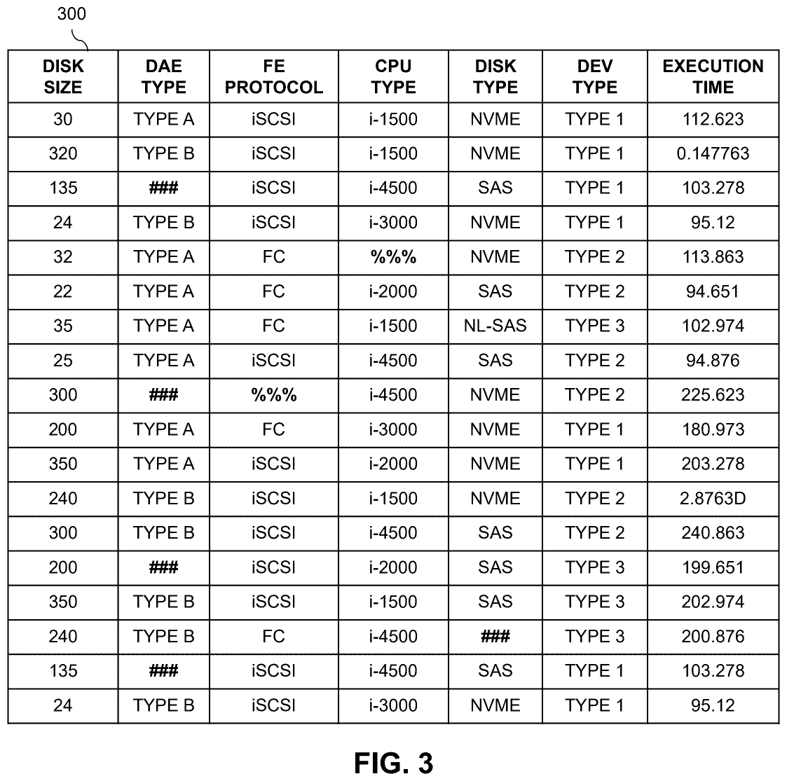

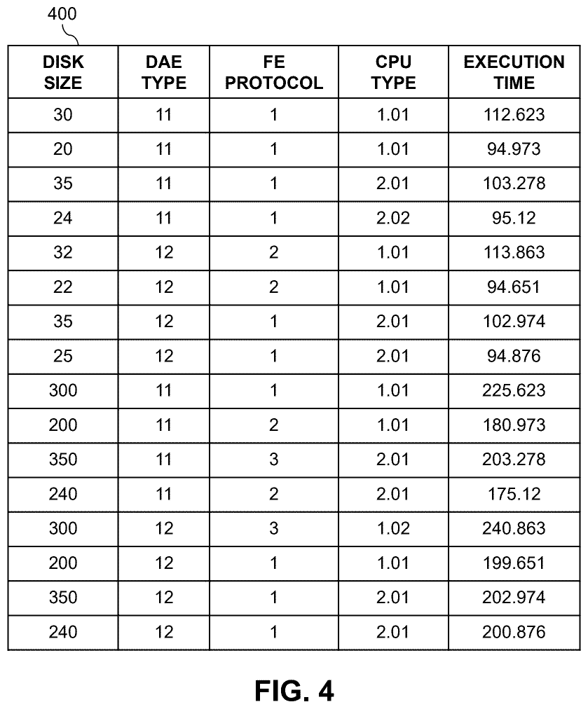

Step 204 preprocesses historical execution data (e.g., from the testing database 108) comprising feature values for the given test case executing on multiple devices (e.g., IT assets 106) to generate training data, as discussed further below in conjunction with FIGS. 3 and 4. In some embodiments, the preprocessing of step 204 may transform the historical execution data to generate the training data. The transformation of the historical execution data may comprise cleaning the historical execution data (e.g., removing invalid rows of data), integrating the historical execution data (for example, generating a sum or an aggregate value) and/or standardizing the historical execution data (such as mapping one or more feature values to predefined categories, numeric values and/or or value ranges), as discussed further below.

A linear regression analysis is performed in step 206 using features extracted from the training data to determine parameter values of the prediction function, as discussed further below in conjunction with FIG. 5. The linear regression analysis (e.g., a gradient descent algorithm and/or a least squares method) fits an execution time curve of a particular test device for the given test case to obtain the parameter values of the prediction function, using a designated confidence level. Generally, the linear regression analysis predicts the value of a first variable (e.g., the independent variable) based on the value of a second variable (e.g., the dependent variable).

The prediction function for the given test case (with the parameter values determined in step 206) is provided in step 208 to populate one or more missing entries of the test case execution time matrix of FIG. 6 for the given test case. The prediction function for the given test case may be used to generate at least one predicted execution time for the given test case using at least one actual execution time of the given test case on one or more different IT assets than a particular IT asset of interest (e.g., an IT asset where the given test case does not have an execution history).

FIG. 3 is an example table 300 illustrating an execution history for a particular test case according to an embodiment. In the example of FIG. 3, the particular test case is related to a storage system where the important features tend to IO (input/output)-related features and calculation-related features. For example, the features of FIG. 3 extracted from the execution history of the particular test case comprise a disk size feature, a disk array enclosure (DAE) feature, a frontend (FE) protocol feature (e.g., an Internet Small Computer Systems Interface (iSCSI) or a fiber channel (FC)), a central processing unit (CPU) type feature, a disk type feature, and a device (dev) type feature. In addition, the table 300 comprises an execution time label as the dependent variable from each execution of the particular test case in the execution history.

The table 300 comprises a number of boldface entries corresponding to invalid data (noted in FIG. 3 as “% %%”) and/or missing data (noted in FIG. 3 as “###”) (for example, due to a data collection error, a typographical error and/or a missing data value). The table 300 is preprocessed in some embodiments, for example, to remove and/or correct incomplete or invalid rows of data, as discussed further below in conjunction with FIG. 4.

FIG. 4 is a sample table 400 illustrating a preprocessed execution history for the particular test case of FIG. 3 that is used as training data for the linear regression analysis of step 206 according to an embodiment. In the example of FIG. 4, the four features of interest for the particular test case comprise the disk size feature, the DAE feature, the FE protocol feature and the CPU type feature. As noted above, the preprocessing of the historical execution data may comprise, for example, removing invalid rows of data, generating a sum or an aggregate value for a given feature and/or mapping one or more feature values to predefined categories, numeric values and/or or value ranges. For example, the CPU type values of FIG. 3 are mapped to a number in FIG. 4.

FIG. 5 comprises example tables 500, 550 indicating a regression statistics summary and prediction function coefficients, respectively, according to embodiments of the disclosure. In the example table 500, a statistics summary is provided for the linear regression analysis performed in step 206 of the process of FIG. 2 using the preprocessed features in the sample table 400 of FIG. 4. In statistics, r is referred to as a correlation coefficient (and is sometimes referred to as the “Pearson product-moment correlation coefficient”). Multiple R (e.g., the “multiple correlation coefficient”) provides a measure of the goodness of fit of the regression model (e.g., a measure of whether the prediction is accurate). In the example of FIG. 5, the generated multiple R value of 0.975288418 indicates that the independent variables (e.g., the four features of FIG. 4) and the dependent variable (e.g., the execution time label of FIG. 4) have a high positive correlation.

In addition, the R-squared and adjusted R-squared values comprise statistics derived from analyses based on a general linear model (e.g., regression) and represent a proportion of the variance in the outcome variable that is explained by the predictor variables in the sample (R-squared) and an estimate in the population (adjusted R-squared). In the example table 500 of FIG. 5, the regression analysis generated an R-squared value of 0.0.951187499 and an adjusted R-squared value of 0.933437498.

The standard error shown in FIG. 5 measures the average vertical distance (e.g., the error) between points on a scatter diagram and a regression line. The standard error of the estimate is a measure of the standard deviation of the errors in a regression model. In the example of FIG. 5, the regression analysis generated a standard error value of 14.19283342. Finally, the table 500 indicates that 16 observations were considered, corresponding to the 16 rows of FIG. 4.

As noted above, the test case execution time prediction function (h_{θ}(x)) template may be expressed as follows:

$${h}_{θ} ( x ) = {θ}_{0} + {θ}_{1} {x}_{1} + {θ}_{2} {x}_{2} + … + {θ}_{k} {x}_{k} ,$$

where x₁, x₂, x₃, . . . , xₖ are input features extracted from the training data (e.g., FIG. 4) for the particular test case and θ₀, θ₁, θ₂, . . . θₖ are parameter values (e.g., weights) of the test case execution time prediction function.

In the example table 550, the intercept, θ₀, of the regression line is 46.63180605, the x₁ coefficient has a value of 0.410904663 for the disk size feature, the x₂ coefficient has a value of 72.10684586 for the DAE type feature, the x₃ coefficient has a value of −4.133717916 for the FE protocol feature and the x₄ coefficient has a value of −21.63973063 for the CPU type feature. The standard error for each value is also shown in the example table 550. Thus, the above test case execution time prediction function (h_{θ}(x)) template may be expressed, as follows:

$${h}_{θ} ( x ) = 46.63180605 + 0.410904663 {x}_{1} + 72.10684586 {x}_{2} - 4.133717916 {x}_{3} - 21. 63973063 {x}_{4} .$$

The populated test case execution time prediction function (h_{θ}(x)) generated in accordance with the table 550 of FIG. 5 is used to generate one or more predicted execution times for a given test case on one or more test devices where an execution history is not available for the given test case (e.g., to predict the execution time of the given test case on new (e.g., previously unseen) test devices).

FIG. 6 is an example table illustrating a test case execution time matrix 600, according to an embodiment. The test case execution time matrix 600 (sometimes referred to as Tₘₐₚ) may generally be expressed as an m*n matrix, where element tᵢⱼ reflects the execution time of device dᵢ for test case cⱼ, as follows:

$${T}_{map} = [ \begin{matrix}t ( {d}_{1} ) \\ ⋮ \\ t ( {d}_{m} )\end{matrix} ] = [ \begin{matrix}{t}_{11} {t}_{12} & ⋯ & {t}_{1 n} \\ ⋮ & ⋱ & ⋮ \\ {t}_{m 1} {t}_{m 2} & ⋯ & {t}_{mn}\end{matrix} ] .$$

In the example of FIG. 6, the test case execution time matrix 600 comprises some tᵢⱼ values reflecting actual historical execution times (where a given test case cⱼ was executed on a particular test device dᵢ) and some predicted execution times (where a given test case cⱼ was not previously executed on a particular test device dᵢ). If a given test device is unable to execute a particular test case (for example, if the given test device does not have required hardware, such as a required disk type), the corresponding element of the test case execution time matrix 600 will be assigned an execution times value of ∞ (infinity). In this manner, the value of ∞ ensures that the given test device will not be selected for the particular test case in the automated scheduling of the particular test case.

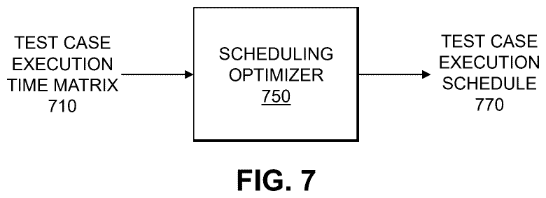

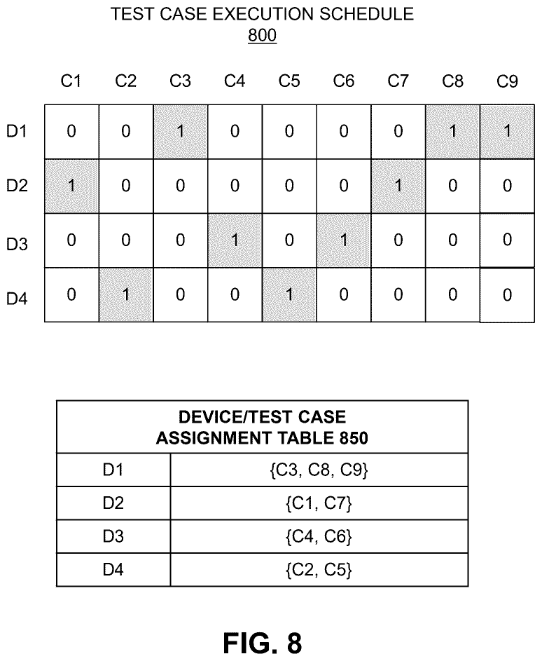

FIG. 7 illustrates a scheduling optimizer 750 in an illustrative embodiment. In the example of FIG. 7, the scheduling optimizer 750 processes a test case execution time matrix 710, such as the test case execution time matrix of FIG. 6, in a manner described hereinafter, and generates a test case execution schedule 770, as discussed further below in conjunction with FIG. 8.

In at least some embodiments, the scheduling optimizer 750 employs one or more of the following constraints when scheduling an execution of one or more test cases on test devices:
each test case is an independent task with indivisibility;
each test device can only execute one test case at a time;
test cases have the same priority;
after execution of a test case is completed on a particular test device, the particular test device can immediately start running the next test case; and
a given test case executes at a known time on a particular test device.

Consider again the example system having N test cases and M free test devices. If any of the M test devices starts to execute a test case, after each given test device completes a respective test case, the given test device immediately selects a new test case that has not been executed and starts running the new test case, until all N test cases have been executed. The time from the start of an execution of a first test case to the completion of the last test case is referred to as the total completion time, T. The scheduling optimizer 750, in some embodiments, seeks an optimal solution that minimizes the total completion time, T, according to the following expression:

$$T = {max}_{1 \leq i \leq m} \{ {\sum }_{j = 1}^{n} {t}_{ij} {x}_{ij} \} ,$$

$$such that$$

$${\sum }_{i = 1}^{m} {x}_{ij} = 1$$

$$j = 1 , 2 , … n ,$$

where:

$${x}_{ij} = \{ \text{} \begin{matrix}0 ( device {d}_{i} is not assigned to execute test case {c}_{i} ) & i = 1 … m , j = 1 … n \\ 1 ( device {d}_{i} is assigned to execute test case {c}_{i} ) & i = 1 … m , j = 1 … n ;\end{matrix}$$

T: total completion time; and
tᵢⱼ: run time of test device dᵢ on test case cᵢ.

The scheduling optimizer 750, in some embodiments, may employ one or more of the following exemplary optimization methods: a greedy algorithm, a simulated annealing algorithm and a genetic algorithm to generate a test case execution schedule 770 that substantially minimizes the total completion time, T.

FIG. 8 comprises an exemplary test case execution schedule 800 and a device/test case assignment table 850, according to embodiments of the disclosure. In the example of FIG. 8, a scheduling solution is provided that substantially minimizes the total completion time, T, for a system comprising four test devices and nine test cases. In the test case execution schedule 800 of FIG. 8, if a given device, Dᵢ, is assigned by the scheduling optimizer 750 to execute a particular test case, Cᵢ, then the corresponding cell is populated with a binary value of one. Similarly, if a given device, Dᵢ, is not assigned to execute a particular test case, Cᵢ, then the corresponding cell is populated with a binary value of zero.

The exemplary device/test case assignment table 850 of FIG. 8 identifies the test cases, Cᵢ, that are assigned by the scheduling optimizer 750 to execute on each test device, Dᵢ. As noted above, after execution of a test case is completed on a particular test device, the particular test device can immediately start running the next test case. In the example of FIG. 8, the completion time for device 1 is 90 time units, using the completion times for test cases C3, C8 and C9 on device D1, as shown in FIG. 6. Likewise, the completion times for devices D2, D3 and D4 are 90, 90 and 100 time units, respectively. Thus, the total completion time for the system is 100 time units, corresponding to the completion time of device D4 (e.g., the maximum completion time among the devices D1-D4).

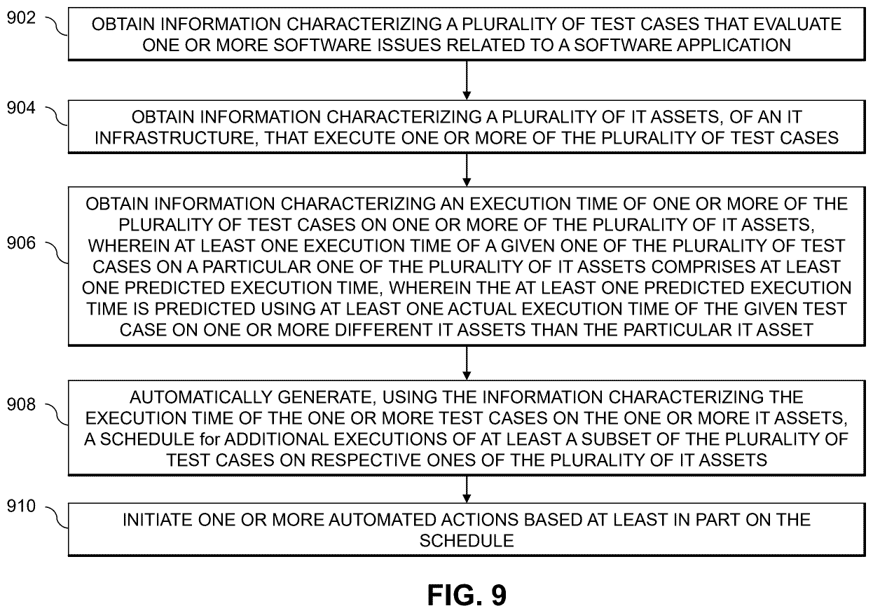

FIG. 9 is a flow diagram illustrating an exemplary implementation of a process for automated scheduling of software application test case execution on IT assets, according to an embodiment. In the example of FIG. 9, information characterizing a plurality of test cases that evaluate one or more software issues related to a software application is obtained in step 902. In addition, information characterizing a plurality of IT assets, of an IT infrastructure, that execute one or more of the plurality of test cases is obtained in step 904.

In step 906, information is obtained characterizing an execution time of one or more of the plurality of test cases on one or more of the plurality of IT assets, wherein at least one execution time of a given one of the plurality of test cases on a particular one of the plurality of IT assets comprises at least one predicted execution time, wherein the at least one predicted execution time is predicted using at least one actual execution time of the given test case on one or more different IT assets than the particular IT asset.

A schedule is automatically generated in step 908 for additional executions of at least a subset of the plurality of test cases on respective ones of the plurality of IT assets using the information characterizing the execution time of the one or more test cases on the one or more IT assets. One or more automated actions are initiated in step 910 based at least in part on the schedule.

In some embodiments, the schedule substantially minimizes a total execution time of the subset of the plurality of test cases and/or substantially maximizes a utilization of the plurality of IT assets. The automatically generating the schedule to execute the at least the subset of the plurality of test cases may employ a processor-based scheduling optimizer.

In at least one embodiment, the at least one predicted execution time of the given test case is predicted using a prediction function generated using a regression analysis of historical execution data comprising feature values for the given test case executing on the one or more different IT assets than the particular IT asset. The historical execution data may be transformed to generate training data used to generate the prediction function, wherein the transformation of the historical execution comprises: cleaning at least some of the historical execution data, integrating at least some of the historical execution data and/or standardizing at least some of the historical execution data. The prediction function may be used to populate one or more missing entries of a test case execution time matrix.

In one or more embodiments, a total execution time to execute the at least the subset of the plurality of test cases comprises a maximum one a plurality of sums of the execution times of the at least the subset of the plurality of test cases on the respective ones of the IT assets.

The particular processing operations and other network functionality described in conjunction with FIGS. 2, 7 and 9, for example, are presented by way of illustrative example only, and should not be construed as limiting the scope of the disclosure in any way. Alternative embodiments can use other types of processing operations to provide functionality for automated scheduling of software application test case execution on IT assets. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

Various techniques exist for scheduling the execution of such test cases, such as a random selection of test cases to execute on information technology (IT) assets and/or a fixed mapping of test cases to execute on such IT assets. Such test case scheduling techniques, however, can result in a test case execution schedule that does not provide an efficient utilization of resources.

In at least some embodiments, the disclosed techniques for automatically scheduling software application test case execution employ machine learning techniques to predict an execution time for one or more test cases executing on one or more IT assets. The disclosed automated test case scheduling techniques automictically assign and distribute test cases among available test devices. In some embodiments, the disclosed automated test case scheduling techniques provide a test case execution schedule that substantially minimizes the total completion time, T, and improves the utilization of resources, relative to existing techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for automated scheduling of software application test case execution on IT assets will now be described in greater detail with reference to FIGS. 10 and 11. Although described in the context of information processing system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100 in FIG. 1. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of information processing system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112.

The processor 1110 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for automated scheduling of software application test case execution on IT assets as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, test cases, test case execution histories, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining information characterizing a plurality of test cases that evaluate one or more software issues related to a software application;
obtaining information characterizing a plurality of information technology (IT) assets, of an IT infrastructure, that execute one or more of the plurality of test cases;
obtaining information characterizing an execution time of one or more of the plurality of test cases on one or more of the plurality of IT assets, wherein at least one execution time of a given one of the plurality of test cases on a particular one of the plurality of IT assets comprises at least one predicted execution time, wherein the at least one predicted execution time is predicted using at least one actual execution time of the given test case on one or more different IT assets than the particular IT asset;
automatically generating, using the information characterizing the execution time of the one or more test cases on the one or more IT assets, a schedule for additional executions of at least a subset of the plurality of test cases on respective ones of the plurality of IT assets; and
initiating one or more automated actions based at least in part on the schedule;
wherein the method is performed by at least one processing device comprising a processor coupled to a memory.

2. The method of claim 1, wherein the schedule one or more of substantially minimizes a total execution time of the subset of the plurality of test cases and substantially maximizes a utilization of the plurality of IT assets.

3. The method of claim 1, wherein the at least one predicted execution time of the given test case is predicted using a prediction function generated using a regression analysis of historical execution data comprising feature values for the given test case executing on the one or more different IT assets than the particular IT asset.

4. The method of claim 3, further comprising transforming the historical execution data to generate training data used to generate the prediction function, wherein the transforming the historical execution data comprises one or more of: cleaning at least some of the historical execution data, integrating at least some of the historical execution data and standardizing at least some of the historical execution data.

5. The method of claim 3, wherein the prediction function is used to populate one or more missing entries of a test case execution time matrix.

6. The method of claim 1, wherein the automatically generating the schedule to execute the at least the subset of the plurality of test cases employs a processor-based scheduling optimizer.

7. The method of claim 1, wherein a total execution time to execute the at least the subset of the plurality of test cases comprises a maximum one of a plurality of sums of the execution times of the at least the subset of the plurality of test cases on the respective ones of the IT assets.

8. An apparatus comprising:
at least one processing device comprising a processor coupled to a memory;
the at least one processing device being configured to implement the following steps:
obtaining information characterizing a plurality of test cases that evaluate one or more software issues related to a software application;
obtaining information characterizing a plurality of information technology (IT) assets, of an IT infrastructure, that execute one or more of the plurality of test cases;
obtaining information characterizing an execution time of one or more of the plurality of test cases on one or more of the plurality of IT assets, wherein at least one execution time of a given one of the plurality of test cases on a particular one of the plurality of IT assets comprises at least one predicted execution time, wherein the at least one predicted execution time is predicted using at least one actual execution time of the given test case on one or more different IT assets than the particular IT asset;
automatically generating, using the information characterizing the execution time of the one or more test cases on the one or more IT assets, a schedule for additional executions of at least a subset of the plurality of test cases on respective ones of the plurality of IT assets; and
initiating one or more automated actions based at least in part on the schedule.

9. The apparatus of claim 8, wherein the schedule one or more of substantially minimizes a total execution time of the subset of the plurality of test cases and substantially maximizes a utilization of the plurality of IT assets.

10. The apparatus of claim 8, wherein the at least one predicted execution time of the given test case is predicted using a prediction function generated using a regression analysis of historical execution data comprising feature values for the given test case executing on the one or more different IT assets than the particular IT asset.

11. The apparatus of claim 10, further comprising transforming the historical execution data to generate training data used to generate the prediction function, wherein the transforming the historical execution data comprises one or more of: cleaning at least some of the historical execution data, integrating at least some of the historical execution data and standardizing at least some of the historical execution data.

12. The apparatus of claim 10, wherein the prediction function is used to populate one or more missing entries of a test case execution time matrix.

13. The apparatus of claim 8, wherein the automatically generating the schedule to execute the at least the subset of the plurality of test cases employs a processor-based scheduling optimizer.

14. The apparatus of claim 8, wherein a total execution time to execute the at least the subset of the plurality of test cases comprises a maximum one of a plurality of sums of the execution times of the at least the subset of the plurality of test cases on the respective ones of the IT assets.

15. A non-transitory processor-readable storage medium having stored therein program code of one or more software programs, wherein the program code when executed by at least one processing device causes the at least one processing device to perform the following steps:
obtaining information characterizing a plurality of test cases that evaluate one or more software issues related to a software application;
obtaining information characterizing a plurality of information technology (IT) assets, of an IT infrastructure, that execute one or more of the plurality of test cases;
obtaining information characterizing an execution time of one or more of the plurality of test cases on one or more of the plurality of IT assets, wherein at least one execution time of a given one of the plurality of test cases on a particular one of the plurality of IT assets comprises at least one predicted execution time, wherein the at least one predicted execution time is predicted using at least one actual execution time of the given test case on one or more different IT assets than the particular IT asset;
automatically generating, using the information characterizing the execution time of the one or more test cases on the one or more IT assets, a schedule for additional executions of at least a subset of the plurality of test cases on the respective ones of the plurality of IT assets; and
initiating one or more automated actions based at least in part on the schedule.

16. The non-transitory processor-readable storage medium of claim 15, wherein the schedule one or more of substantially minimizes a total execution time of the subset of the plurality of test cases and substantially maximizes a utilization of the plurality of IT assets.

17. The non-transitory processor-readable storage medium of claim 15, wherein the at least one predicted execution time of the given test case is predicted using a prediction function generated using a regression analysis of historical execution data comprising feature values for the given test case executing on the one or more different IT assets than the particular IT asset.

18. The non-transitory processor-readable storage medium of claim 17, further comprising transforming the historical execution data to generate training data used to generate the prediction function, wherein the transforming the historical execution data comprises one or more of: cleaning at least some of the historical execution data, integrating at least some of the historical execution data and standardizing at least some of the historical execution data.

19. The non-transitory processor-readable storage medium of claim 15, wherein the automatically generating the schedule to execute the at least the subset of the plurality of test cases employs a processor-based scheduling optimizer.

20. The non-transitory processor-readable storage medium of claim 15, wherein a total execution time to execute the at least the subset of the plurality of test cases comprises a maximum one a plurality of sums of the execution times of the at least the subset of the plurality of test cases on the respective ones of the IT assets.
